(19) United States
(12) Patent Application Publication
(10) Pub. No.: US 2026/0122080 A1
(43) Pub. Date: Apr. 30, 2026

(54) MONITORING OF NEWLY OBSERVED DOMAINS

(71) Applicant: Palo Alto Networks, Inc., Santa Clara, CA (US)

(72) Inventors: Shu Wang, San Jose, CA (US); Zhanhao Chen, Sunnyvale, CA (US); Ruian Duan, Fremont, CA (US); Daiping Liu, Santa Clara, CA (US)

(21) Appl. No.: 18/932,178

(22) Filed: Oct. 30, 2024

(51) Int. Cl. H04L 9/40

(52) U.S. Cl. CPC H04L 63/1416

(57) ABSTRACT

One or more identifications of one or more newly observed domains are received. The one or more newly observed domains are store in a newly observed domain watch list for a specified watch interval. One or more automatic analyses are periodically performed to determine whether any newly observed domain stored in the newly observed domain watch list for the specified watch interval is determined to be suspicious or malicious.

### BACKGROUND OF THE INVENTION

Malicious actors often use newly registered domains for various cyberattacks due to their fresh and unrecognized status. For example, new domains are created to appear benign by linking them to benign nameserver IP addresses for a period of time before redirecting them to attackers'dedicated Command and Control servers to conduct cyberattacks. Current security systems primarily focus on identifying malicious patterns at the moment of first observation of new domains. However, newly registered domains may be inactive or benign for a period of time before malicious actors prepare and use the new domains to conduct cyberattacks. Therefore, there exists a need for more timely and effective ways to detect malicious new domains.

### BRIEF DESCRIPTION OF THE DRAWINGS

Various embodiments of the invention are disclosed in the following detailed description and the accompanying drawings.

FIG. 1 is a block diagram illustrating an example of a network environment for performing proactive monitoring of newly observed domains.

FIG. 2 is a flow chart illustrating an embodiment of a process for monitoring newly observed domains.

FIG. 3 is a flow chart illustrating an embodiment of a process for evaluating a malicious intent of a newly observed domain.

FIG. 4 is a flow chart illustrating an embodiment of a process for automatic lexical analyses of a newly observed domain.

FIG. 5 is a flow chart illustrating an embodiment of a process for handling a newly observed domain after automatic analyses.

FIG. 6 is a flow chart illustrating an embodiment of a process for removing a newly observed domain after its specified watch interval expires.

FIG. 7 is a functional diagram illustrating a programmed computer system for performing proactive monitoring of newly observed domains.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Proactive monitoring of newly observed domains is disclosed. In some embodiments, a list of newly observed domains is received. For example, the list of newly observed domains is obtained from one or more DNS servers. The newly observed domains are placed on a watch list for a specified interval and monitored by various automatic processes. In some embodiments, the automatic processes include evaluating the lexical pattern of the domain name of a newly observed domain using previously identified malicious and benign domains and a machine learning model. The use of a machine learning model allows semantic meaning of domain names to be quantified and compared to known malicious domain names. In some embodiments, the automatic processes include checking the domain's features against databases of known malicious domains and their features and monitoring the data traffic of the newly observed domains for bursts of activity. After significant results are obtained from the automatic analysis or after the specified watch interval has passed, a security label associated with the results of the automatic analysis is determined for the newly observed domain, and the newly observed domain is removed from the watch list. In some embodiments, a security action is performed based on the determined security label.

In some embodiments, one or more identifications of one or more newly observed domains is received. For example, passive Domain Name System (DNS) records representing newly observed domains are received from one or more DNS servers. One or more of the newly observed domains are stored in a newly observed domain watch list for a specified watch interval. For example, one or more of the newly observed domains are stored in a database or system. One or more automatic analyses are periodically performed to determine whether any newly observed domain stored in the newly observed domain watch list for the specified watch interval is determined to be suspicious or malicious. For example, lexical analysis is performed on the domain and subdomain of a newly observed domain. As another example, for each newly observed domain in the watch list, the domain's features and registration information are checked against one or more databases of previously identified malicious domains. An additional example includes the monitoring of data traffic of the newly observed domain for suspicious activity. In some embodiments, the results of the automatic analyses are combined to determine an overall evaluation score for the malicious nature of each newly observed domain. By analyzing the lexical patterns of the newly observed domains, patterns in the creation of new domains by malicious actors can be used to identify how likely a newly observed domain will be used maliciously in the future, allowing early detection of malicious newly observed domains. Additionally, by proactively monitoring the newly observed domains for a specified period of time, malicious changes to the domain's features or suspicious activity can be detected before the newly observed domain is used in a cyberattack.

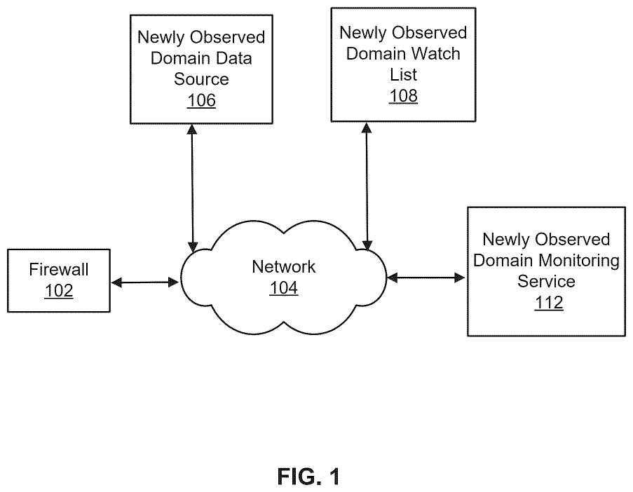

FIG. 1 is a block diagram illustrating an example of a network environment for performing proactive monitoring of newly observed domains. In the example shown, firewall 102, newly observed domain data source 106, newly observed domain watch list 108, and newly observed domain monitoring service 112 are connected via network 104. Network 104 can be a public or private network. In some embodiments, network 104 is a public network such as the internet. Examples of network 104 include one or more of the following: a direct or indirect physical communication connection, internet, intranet, Local Area Network, Wide Area Network, Storage Area Network, and any other form of connecting two or more systems, components, or storage devices together. In various embodiments, newly observed domain monitoring service 112 is communicatively connected to firewall 102 and offers its domain monitoring service to clients using firewall 102. For example, clients using firewall 102 can provide settings, categories, preferences, or filters to firewall 102 for newly observed domain monitoring service 112 to use.

In some embodiments, newly observed domain data source 106 provides newly observed domains to newly observed domain watch list 108 via network 104. For example, newly observed domain data source 106 is a database containing domain names and internet protocol (IP) addresses from passive DNS at one or more DNS servers. In some embodiments, domain names and IP addresses are cached into newly observed domain data source 106 when received by firewall 102. In various embodiments, newly observed domains stored in newly observed domain data source 106 are automatically put in newly observed domain watch list 108. In some embodiments, newly observed domains are periodically deposited into newly observed domain watch list 108. Newly observed domains can be stored as records, files, vectors, text, data entries, or any other method of storing data.

In some embodiments, newly observed domain monitoring service 112 is one or more servers used to implement a proactive domain monitoring service. Examples of additional components of newly observed domain monitoring service 112 include a machine learning model, a database containing domain information from previous data traffic through firewall 102 or another firewall, and additional data repositories.

In some embodiments, the components shown in FIG. 1 may exist in various combinations of hardware machines. Although single instances of some components have been shown to simplify the diagram, additional instances of the components shown in FIG. 1 may exist. For example, newly observed domain monitoring service 112 can include one or more servers including one or more servers for a machine learning model, a data repository for the machine learning model, and additional data repositories. The included servers can include distributed servers, application servers, and database servers, among others. As shown in FIG. 1, firewall 102 is just one example of a potential implementation of newly observed domain monitoring service 112. In some embodiments, components not shown in FIG. 1 may also exist.

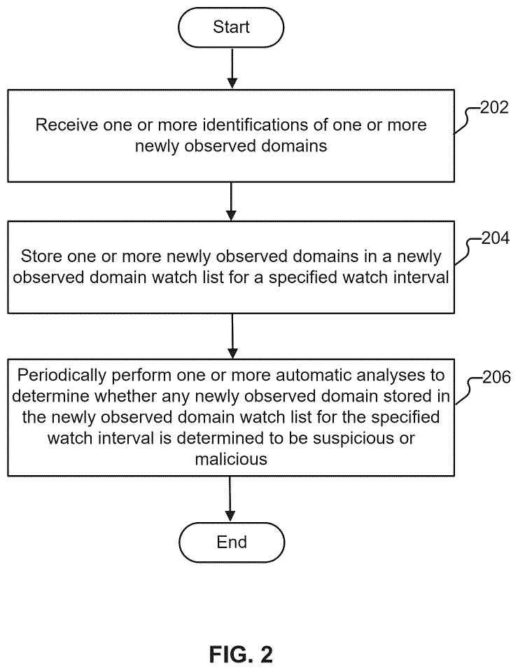

FIG. 2 is a flow chart illustrating an embodiment of a process for monitoring newly observed domains. For example, using the process of FIG. 2, newly observed domains are proactively monitored for malicious intent and an appropriate security action is performed based on the results of the proactive monitoring. In some embodiments, the process of FIG. 2 is executed by newly observed domain monitoring service 112 of FIG. 1. In some embodiments, the process of FIG. 2 is a feature utilized to update a list of suspicious or malicious domains utilized by a firewall to filter network traffic.

At 202, one or more identifications of one or more newly observed domains are received. In some embodiments, one or more identifications of one or more newly observed domains include passive DNS records collected from one or more DNS servers. For example, DNS servers track records of domains that it has not previously observed. Identifications of a newly observed domain may also include but are not limited to domain name and IP address. In some embodiments, identifications of the newly observed domains are received from newly observed domain data source 106 of FIG. 1. For example, newly observed domains are received from a passive DNS database. As another example, newly observed domains are retrieved from traffic of DNS security services of a communicatively connected firewall, such as firewall 102 of FIG. 1.

At 204, one or more newly observed domains are stored in a newly observed domain watch list for a specified watch interval. For example, the received newly observed domains are stored as entries in a database. In some embodiments, one or more newly observed domains are stored in newly observed domain watch list 108 of FIG. 1. Each newly observed domain may be stored in newly observed domain watch list 108 as a file, record, text, vector, or any other method of storing data. In some embodiments, the specified watch interval is associated with historical patterns of malicious actors using newly observed domains. In some embodiments, the specified watch interval is a predetermined amount of time. In some embodiments, the specified watch interval is configurable. In some embodiments, the specified watch interval is dynamically determined and/or adjusted. For example, a property and/or an analysis of each of the one or more newly observed domains is stored in the newly observed domain watch list for a specific determined amount of time that may be different across the one or more newly observed domains.

At 206, one or more automatic analyses are periodically performed to determine whether any newly observed domains stored in the newly observed domain watch list for the specified watch interval is determined to be suspicious or malicious. For example, features of the newly observed domains are periodically evaluated to determine malicious intent. Evaluated features include but are not limited to the domain name, domain registration information, domain infrastructure, and domain behavior. Domain names may be analyzed for length, complexity, similarity to existing legitimate domains, presence of highly abused words in malicious domains, and associations with previously identified malicious domains. Domain registration information and domain infrastructure, such as WHOIS lookup information, IP addresses, and name servers, may also be retrieved and analyzed against historical data of known malicious domain registration information. In some embodiments, the traffic of the newly observed domains is observed since many malicious newly observed domains contain similar traffic patterns. In some embodiments, the results of these analyses are combined to determine whether a newly observed domain is malicious, suspicious, or benign. Automatic analyses are periodically performed on the newly observed domains until removed from the newly observed domain watch list.

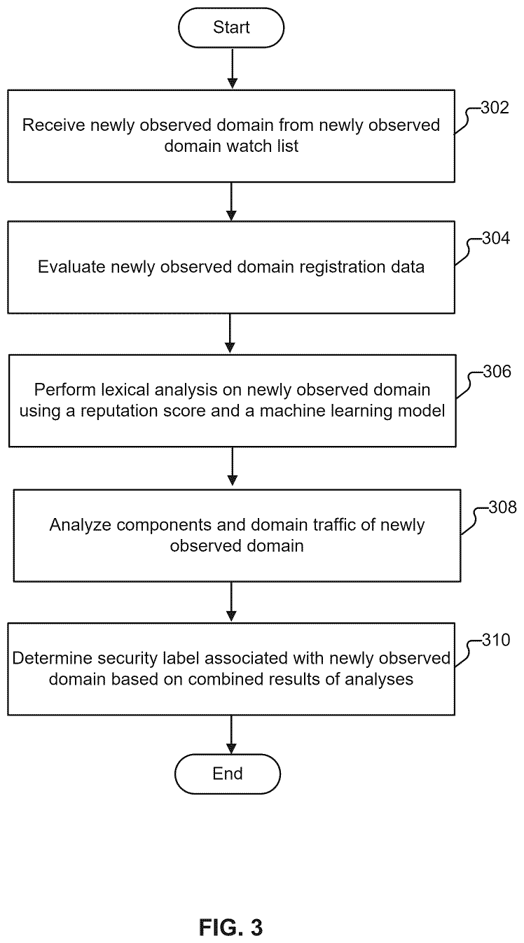

FIG. 3 is a flow chart illustrating an embodiment of a process for evaluating a malicious intent of a newly observed domain. For example, using the process of FIG. 3, various features and components of a newly observed domain are analyzed to determine a security label associated with the newly observed domain. At least a portion of the process of FIG. 3 may be repeated periodically. In some embodiments, the process of FIG. 3 is executed by newly observed domain monitoring service 112 of FIG. 1. In some embodiments, at least a portion of the process of FIG. 3 is included in 206 of FIG. 2. In some embodiments, the process of FIG. 3 is performed as a service to customers using a firewall such as firewall 102 of FIG. 1.

At 302, a newly observed domain is received from the newly observed domain watch list. For example, an identification of a newly observed domain, such as a domain name, IP address, or DNS record, is received. In some embodiments, two or more identifications associated with the same domain are received. In some embodiments, the newly observed domain is received from newly observed domain watch list 108 of FIG. 1. In various embodiments, the newly observed domain is received via network 104 of FIG. 1.

At 304, the newly observed domain registration data is evaluated. For example, registration data associated with the newly observed domain is retrieved and assessed. Registration data of a newly observed domain may include the registrar and registration date obtained through the WHOIS domain database maintained by the Internet Corporation for Assigned Names and Numbers (ICANN). In some embodiments, the WHOIS domain database is accessed through network 104 of FIG. 1. In various embodiments, the registrar data obtained from the WHOIS domain database is compared to a database containing previously identified malicious domains and its registrar data. Other databases or tools, such as domain reputation lookup tools, may be implemented to determine whether the domain was created by a malicious actor. In the event that the registrar of a newly observed domain is identified as a malicious actor, the newly observed domain is determined to be malicious.

At 306, lexical analysis is performed on the newly observed domain using a reputation score and a machine learning model. In some embodiments, the reputation score of the newly observed domain is determined by extracting the subdomain from the domain name and utilizing a labelled database of previous domains. The subdomain is tokenized using natural language processing techniques to split the domain into its words. Once tokenized, the words are analyzed against a database of previous domains containing benign and malicious labels. For example, each word extracted from the domain is queried into the database and a score associated with its frequency and distribution in benign, grayware, or malicious websites is determined. The scores of each word are accumulated in an equal or weighted fashion to determine a reputation score. In particular embodiments, threshold values associated with the reputation scores are used to label the newly observed domains and determine if the newly observed domain is malicious, suspicious, or benign. In some embodiments, lexical analysis is performed using a machine learning model. In some embodiments, the machine learning model is a random forest model. The domain name is split into all its n-grams and each n-gram undergoes term frequency-inverse document frequency computation. The resulting values are combined to create a feature vector representing the newly observed domain. The feature vector is input into a machine learning model and a security label is output. In some embodiments, the machine learning model is a classification model, such as a machine learning model, trained on a database of feature vectors representing malicious and benign newly observed domains and domains. In some embodiments, the outputted security label is used to determine whether the newly observed domain is benign, suspicious, or malicious. In some embodiments, the results of the lexical analyses are combined to determine a security label. For example, if both the reputation score and result from the machine learning model indicate that the newly observed domain is malicious, it is determined that the newly observed domain is malicious. In the event that only one of the lexical analyses indicate the newly observed domain is malicious, the newly observed domain may be marked as grayware or malicious, depending on the firewall settings. In various embodiments, step 306 is performed periodically at a specified interval on the newly observed domain as long as the newly observed domain is in the newly observed domain watch list.

At 308, components and domain traffic of the newly observed domain are analyzed. For example, domain components include but are not limited to IP addresses and name servers. In some embodiments, analyzing an IP address consists of identifying its IP address based on its DNS A or DNS AAAA record and searching a database of malicious IP addresses to determine whether the IP address of the newly observed domain has been used maliciously in the past. In some embodiments, analyzing the current nameservers corresponding to the newly observed domain includes identifying whether the current nameservers associated with the newly observed domain are malicious based on a cyberattack Command and Control (C2) server list. In some embodiments, analyzing the domain traffic of a newly observed domain includes retrieving the historic traffic of the newly observed domain from passive DNS or other DNS security services and the number of DNS requests received for the newly observed domain. Abnormal network traffic patterns of the newly observed domain may indicate that the newly observed domain is suspicious or malicious. In various embodiments, step 308 is performed periodically at a specified interval on the newly observed domain as long as the newly observed domain is in the newly observed domain watch list.

At 310, a security label associated with the newly observed domain is determined based on the combined results of analyses. For example, a security label indicating whether the newly observed domain is malicious, grayware, or benign is determined using the analyses and periodic analyses in the previous steps. In some embodiments, it is determined that the newly observed domain is malicious if any of the analyses indicate the newly observed domain is malicious. In some embodiments, a grayware label is attached to the newly observed domain if the results of the analyses are suspicious but not significant enough for a malicious label. For example, if the lexical analyses indicate that the newly observed domain is suspicious, the newly observed domain may be marked as grayware. In some embodiments, the determined security label associated with the newly observed domain is based on preferences indicated in the firewall. For example, user inputted settings in the firewall may request for suspicious newly observed domains to be marked as malicious.

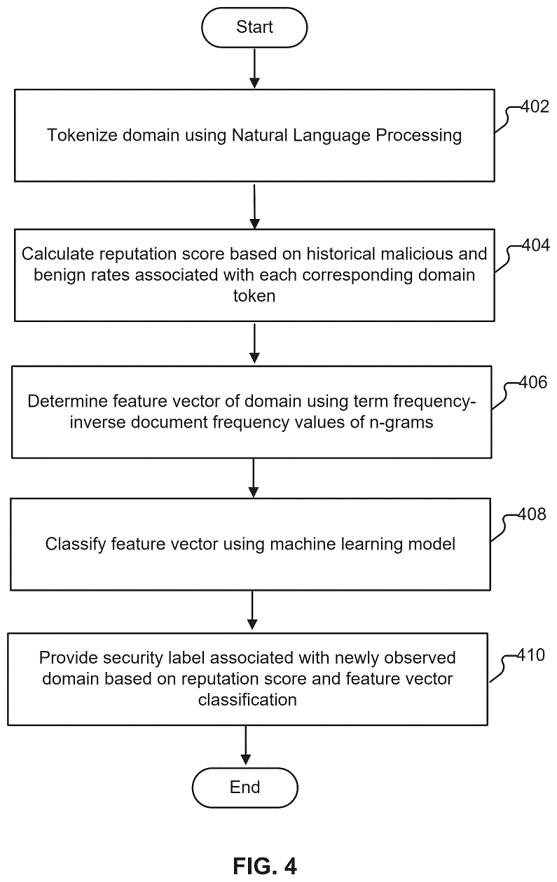

FIG. 4 is a flow chart illustrating an embodiment of a process for automatic lexical analyses of a newly observed domain. For example, using the process of FIG. 4, the domain name of at least one newly observed domain is evaluated for lexical patterns and associations with historical data. In some embodiments, one or more of the automatic analyses include determining a corresponding reputation score for one or more tokens included in at least one newly observed domain such that the reputation score is based on a historical malicious or benign rate associated with the corresponding token. In some embodiments, one or more of the automatic analyses include determining a vector of term frequency-inverse document frequency values of n-grams of at least one newly observed domain and classifying the vector using a machine learning model to determine a suspicious or malicious classification result. In some embodiments, at least a portion of the process of FIG. 4 is included in 306 of FIGS. 3 and 206 of FIG. 2.

At 402, the domain is tokenized using Natural Language Processing. For example, the domain name is parsed into a plurality of components including but not limited to subdomain, second-level domain, and top-level domain. One or more of the components are processed using Natural Language Processing techniques to be segmented into one or more tokens such that the tokens are the same size or smaller than the component and still contain semantic meaning. In some embodiments, the tokens correspond to the words in the subdomain.

At 404, a reputation score based on historical malicious and benign rates associated with each corresponding domain token is calculated. For example, the historical malicious and benign rates associated with each identified token are retrieved. In some embodiments, the historical malicious and benign rates are retrieved from a database containing the names of domains identified as malicious or benign and the words in each of the domains. In some embodiments, the historical malicious and benign rates associated with each corresponding domain token are translated into a scalar value, and a reputation score is computed using the scalar values. The reputation score may be the average, weighted average, sum, weighted sum, maximum value, or any other representation of the scalar values. In some embodiments, the reputation score is represented as a scalar value, symbol, or text.

At 406, a feature vector of the domain is determined using term frequency-inverse document frequency values (TF-IDF) of n-grams. For example, the domain name of the newly observed domain is segmented into n-grams. A TF-IDF value is calculated for each n-gram. In some embodiments, the TF-IDF value is a scalar value. The corresponding TF-IDF values of n-grams are combined to create a feature vector representing the domain name.

At 408, the feature vector is classified using a machine learning model. For example, the feature vector is input into a machine learning model and classified as benign, suspicious, or malicious. In some embodiments, the machine learning model is a random forest model, k-nearest neighbors model, XGBoost model, or any machine learning model that can be used for prediction and or classification. In some embodiments, a model uncertainty analysis is performed to determine whether a feature vector of a newly observed domain is suspicious or malicious. In various embodiments, the machine learning model is trained using feature vectors of domain names with ground truth labels.

At 410, a security label associated with the newly observed domain is provided based on the reputation score and feature vector classification. For example, if the reputation score reaches a threshold value or the feature vector classification result indicates the newly observed domain high low uncertainty, the newly observed domain is labelled as malicious. As another example, if only one of the lexical analyses indicates the newly observed domain is malicious, the newly observed domain is labelled as suspicious. In some embodiments, the reputation score and feature vector classification of the newly observed domain are combined to determine the security label. For example, a total score associated with the reputation score and feature vector classification is calculated for the newly observed domain, and a security label is provided based on predetermined threshold values. In some embodiments, the process of determining a security label is at least in part dictated by the preferences of a user connected to the firewall implementing the automatic analyses of the proactive monitoring domain service.

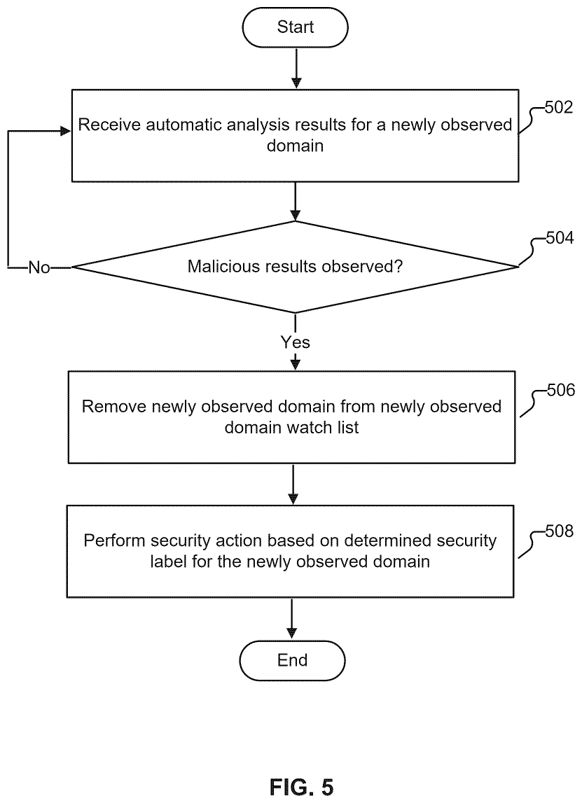

FIG. 5 is a flow chart illustrating an embodiment of a process for handling a newly observed domain after automatic analyses. For example, using the process of FIG. 5, in response to a determination that a specific newly observed domain stored in the newly observed domain watch list is determined to be suspicious or malicious, the newly observed domain is removed from the newly observed domain watch list. As another example, using the process of FIG. 5, in response to a determination that a specific newly observed domain stored in the newly observed domain watch list is determined to be suspicious or malicious, an indication that the specific newly observed domain is associated with greyware or malware is provided and network access associated with the specific newly observed domain is blocked. In some embodiments, the process of FIG. 5 is executed during 206 of FIG. 2. In some embodiments, the process of FIG. 5 is executed after 310 of FIG. 3.

At 502, automatic analyses results for a newly observed domain are received. In some embodiments, the automatic analyses are received from a data repository storing the results of the automatic analyses for newly observed domains. For example, the newly observed domain monitoring service 112 of FIG. 1 contains one or more data repositories for the results of automatic analyses of the newly observed domains in newly observed domain watch list 108 of FIG. 1. In some embodiments, the results of the automatic analyses may be received as various data types or as the same data type. In various embodiments, the automatic analyses results for a newly observed domain are received periodically, or after a batch of automatic analyses have been run on a newly observed domain.

At 504, it is determined whether malicious results are observed. In some embodiments, a suspicious result is considered a malicious result. A malicious or suspicious result may be indicated as a Boolean, a scalar value that exceeds a threshold value, a text label determined during the automatic analyses, or any other method of indicating a score or characteristic of a newly observed domain obtained during the automatic analyses of the newly observed domain. If at 504 it is determined that one or more malicious results are observed among the results of the newly observed domain, the process proceeds to 506. If at 504 it is determined that the results of the newly observed domain do not contain any malicious results, the process returns to 502. In some embodiments, in determining that a newly observed domain does not have malicious results, a different newly observed domain is received at 502. Given that automatic analyses may be performed periodically on the same newly observed domain, a newly observed domain may be evaluated at 504 a plurality of times.

At 506, the newly observed domain is removed from the newly observed domain watch list. In some embodiments, the newly observed domain watch list is newly observed domain watch list 108 of FIG. 1. Once the newly observed domain is dropped from the watch list, the newly observed domain will no longer be proactively monitored. In some embodiments, when a newly observed domain is removed from the newly observed domain watch list, the process of FIG. 2 is executed, such that the dropped newly observed domain is replaced. In some embodiments, the results of the automatic analysis of the newly observed domain are stored in a data repository as new training data for the proactive domain monitoring service.

At 508, a security action based on the determined security label for the newly observed domain is performed. In some embodiments, an indication is provided that the newly observed domain is associated with greyware or malware. For example, a tag, label, or marking is attached to the newly observed domain such that the indication is visible to users of the firewall implementing the proactive monitoring domain service. In some embodiments, network access associated with the specific newly observed domain is blocked. For example, the newly observed domain is added to a block list for a network firewall.

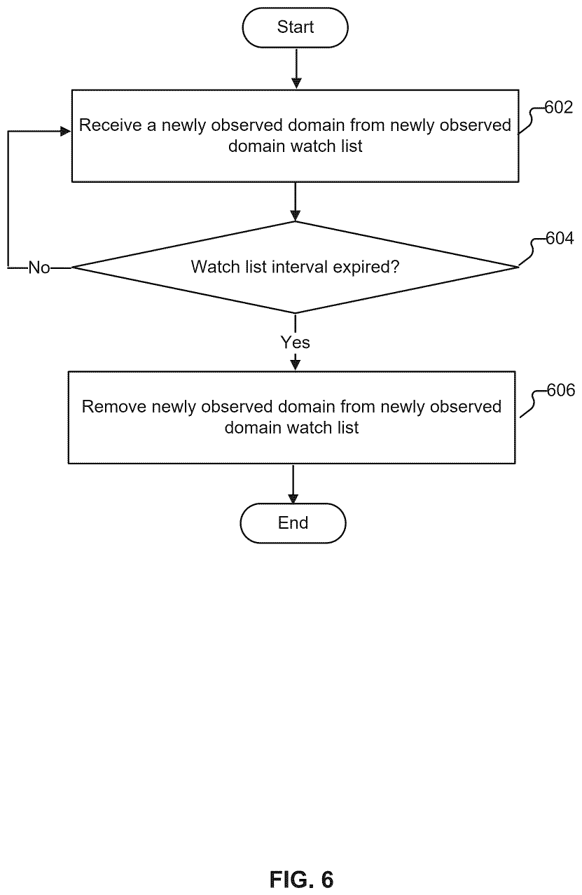

FIG. 6 is a flow chart illustrating an embodiment of a process for removing a newly observed domain after its specified watch interval expires. For example, using the process of FIG. 6, one or more identifications of the newly observed domain are removed from the newly observed domain watch list after a time expiration of the specified watch interval. In some embodiments, the process of FIG. 6 is executed in at least part of step 206 of FIG. 2. In various embodiments, the process of FIG. 6 is repeated periodically.

At 602, a newly observed domain from a newly observed domain watch list is received. In some embodiments, the newly observed domain watch list is newly observed domain watch list 108 of FIG. 1. In some embodiments, the newly observed domain is received as an indication of a newly observed domain, such as a domain name, IP address, or passive DNS record. In various embodiments, newly observed domains are received periodically, such that the same newly observed domain may be received a plurality of times during the watch list interval.

At 604, it is determined whether the watch list interval expired. For example, the newly observed domain is labelled with the beginning, end, or beginning and end of its watch list interval, and it is determined whether the watch list interval has passed. If at 604 it is determined that the watch list interval has expired, the process proceeds to 606. If at 604 it is determined that the watch list interval has not expired, the process returns to 602. In some embodiments, the watch list interval is specified by the user of the network firewall or the operator of the proactive domain monitoring service.

At 606, the newly observed domain is removed from the newly observed domain watch list. For example, one or more identifications of the newly observed domain are removed from the newly observed domain watch list, such that there is no reference to the newly observed domain from the newly observed domain watch list. In some embodiments, the results of the automatic analysis of the newly observed domain are stored in a data repository as new training data for the proactive domain monitoring service.

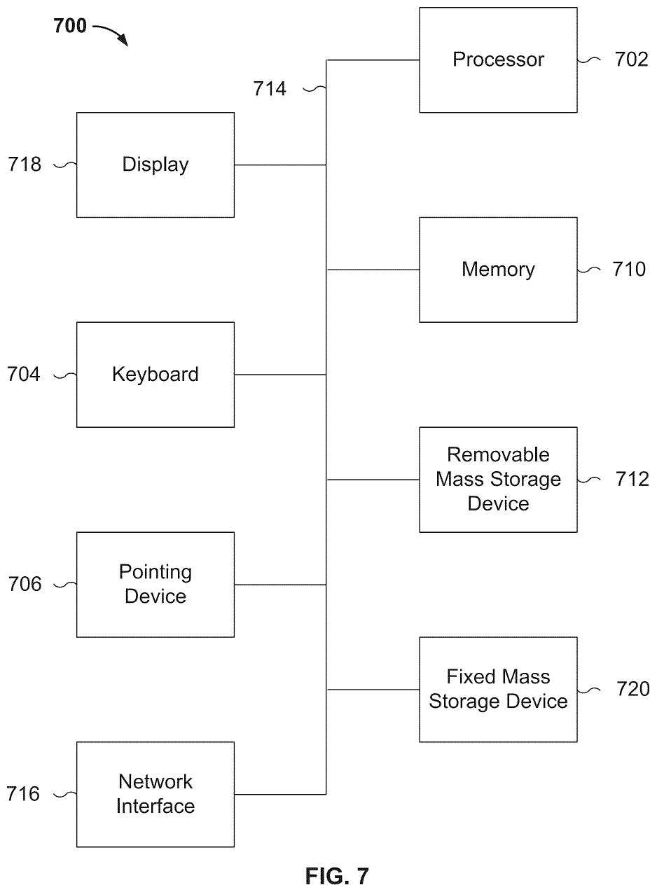

FIG. 7 is a functional diagram illustrating a programmed computer system for performing proactive monitoring of newly observed domains. As will be apparent, other computer system architectures and configurations can be utilized for performing proactive monitoring of newly observed domains with enriched patterns. Examples of computer system 700 include firewall 102 of FIG. 1, one or more computers used to implement newly observed domain data source 106 of FIG. 1, one or more computers used to implement newly observed domain watch list 108 of FIG. 1, and one or more computers used to implement newly observed domain monitoring service 112 of FIG. 1. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718). In various embodiments, one or more instances of computer system 700 can be used to implement at least portions of the processes of FIGS. 2 through 6.

Processor 702 is coupled bi-directionally with memory 710, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data and objects used by the processor 702 to perform its functions (e.g., programmed instructions). For example, memory 710 can include any suitable computer-readable storage media, described below, depending on whether, for example, data access needs to be bi-directional or unidirectional. For example, processor 702 can also directly and very rapidly retrieve and store frequently needed data in a cache memory (not shown).

A removable mass storage device 712 provides additional data storage capacity for the computer system 700, and is coupled either bi-directionally (read/write) or unidirectionally (read only) to processor 702. For example, storage 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of mass storage 720 is a hard disk drive. Mass storages 712, 720 generally store additional programming instructions, data, and the like that typically are not in active use by the processor 702. It will be appreciated that the information retained within mass storages 712 and 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, the pointing device 706 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving one or more identifications of one or more newly observed domains;
storing in a newly observed domain watch list for a specified watch interval, the one or more newly observed domains; and
periodically performing one or more automatic analyses to determine whether any newly observed domain stored in the newly observed domain watch list for the specified watch interval is determined to be suspicious or malicious.

2. The method of claim 1, wherein the one or more identifications of the one or more newly observed domains include passive Domain Name System (DNS) records collected from one or more DNS servers.

3. The method of claim 1, wherein performing the one or more automatic analyses includes determining for at least one newly observed domain stored in the newly observed domain watch list, a corresponding reputation score for one or more tokens included in the at least one newly observed domain.

4. The method of claim 3, wherein the corresponding reputation score is based on a historical malicious or benign rate associated with a corresponding token.

5. The method of claim 1, wherein performing the one or more automatic analyses includes determining a vector of term frequency-inverse document frequency values of n-grams of at least one newly observed domain stored in the newly observed domain watch list and classifying the vector using a machine learning model to determine a suspicious or malicious classification result.

6. The method of claim 5, wherein the machine learning model is a random forest model.

7. The method of claim 1, wherein performing the one or more automatic analyses includes determining for at least one newly observed domain stored in the newly observed domain watch list whether an Internet Protocol (IP) address associated with the at least one newly observed domain in a Domain Name System (DNS) record is determined to be suspicious or malicious.

8. The method of claim 1, wherein performing the one or more automatic analyses includes determining for at least one newly observed domain stored in the newly observed domain watch list whether a nameserver associated with the at least one newly observed domain is determined to be suspicious or malicious.

9. The method of claim 1, wherein performing the one or more automatic analyses includes determining for at least one newly observed domain stored in the newly observed domain watch list whether a network traffic pattern associated with the at least one newly observed domain is determined to be suspicious or abnormal.

10. The method of claim 1, further comprising removing the one or more identifications of the one or more newly observed domains from the newly observed domain watch list after a time expiration of the specified watch interval.

11. The method of claim 1, further comprising in response to a determination that a specific newly observed domain stored in the newly observed domain watch list is determined to be suspicious or malicious, providing an indication that the specific newly observed domain is associated with greyware or malware.

12. The method of claim 1, further comprising in response to a determination that a specific newly observed domain stored in the newly observed domain watch list is determined to be suspicious or malicious, blocking network access associated with the specific newly observed domain.

13. The method of claim 1, further comprising in response to a determination that a specific newly observed domain stored in the newly observed domain watch list is determined to be suspicious or malicious, removing the specific newly observed domain from the newly observed domain watch list.

14. The method of claim 13, further comprising including the specific newly observed domain in a block list for a network firewall.

15. A system, comprising:
one or more processors configured to:
receive one or more identifications of one or more newly observed domains;
store in a newly observed domain watch list for a specified watch interval, the one or more newly observed domains; and
periodically perform one or more automatic analyses to determine whether any newly observed domain stored in the newly observed domain watch list for the specified watch interval is determined to be suspicious or malicious; and
a memory coupled to at least one of the one or more processors and configured to provide the at least one of the one or more processors with instructions.

16. The system of claim 15, wherein performing the one or more automatic analyses includes determining for at least one newly observed domain stored in the newly observed domain watch list, a corresponding reputation score for one or more tokens included in the at least one newly observed domain.

17. The system of claim 15, wherein performing the one or more automatic analyses includes determining a vector of term frequency-inverse document frequency values of n-grams of at least one newly observed domain stored in the newly observed domain watch list and classifying the vector using a machine learning model to determine a suspicious or malicious classification result.

18. The system of claim 15, wherein performing the one or more automatic analyses includes determining for at least one newly observed domain stored in the newly observed domain watch list whether an Internet Protocol (IP) address associated with the at least one newly observed domain in a Domain Name System (DNS) record is determined to be suspicious or malicious.

19. The system of claim 15, wherein performing the one or more automatic analyses includes determining for at least one newly observed domain stored in the newly observed domain watch list whether a nameserver associated with the at least one newly observed domain is determined to be suspicious or malicious.

20. A computer program product embodied in a non-transitory computer readable medium and comprising computer instructions for:
receiving one or more identifications of one or more newly observed domains;
storing in a newly observed domain watch list for a specified watch interval, the one or more newly observed domains; and
periodically performing one or more automatic analyses to determine whether any newly observed domain stored in the newly observed domain watch list for the specified watch interval is determined to be suspicious or malicious.
